(19) United States
(12) Patent Application Publication
(10) Pub. No.: US 2025/0030124 A1
(43) Pub. Date: Jan. 23, 2025

(54) SEPARATOR FOR RECHARGEABLE LITHIUM BATTERY AND RECHARGEABLE LITHIUM BATTERY INCLUDING THE SAME

(71) Applicant: Samsung SDI Co., Ltd., Yongin-si (KR)

(72) Inventors: Yeonho LEE, Yongin-si (KR); Jungseong LEE, Yongin-si (KR); Hyeonseon Choi, Yongin-si (KR); Byongjoon HAN, Yongin-si (KR); Jongjin LEE, Yongin-si (KR); Yangseob KIM, Yongin-si (KR); Byung-Soo KIM, Yongin-si (KR)

(21) Appl. No.: 18/417,275

(22) Filed: Jan. 19, 2024

(30) Foreign Application Priority Data
Jul. 13, 2023 (KR) 10-2023-0091251

(51) Int. Cl. H01M 50/449; H01M 10/0525; H01M 10/44; H01M 50/426; H01M 50/443; H01M 50/446

(52) U.S. Cl. CPC H01M 50/449; H01M 10/0525; H01M 10/44; H01M 50/426; H01M 50/443; H01M 50/446

(57) ABSTRACT

A separator for a rechargeable lithium battery, the separator includes a substrate; a heat resistant layer on the substrate; and an adhesive layer on the heat resistant layer, wherein the heat resistant layer includes inorganic particles, and a salt-based heat resistant binder, the adhesive layer includes a first adhesive binder including PVdF-acrylate; a PVdF homopolymer second adhesive binder; and a P(VdF-co-HFP) copolymer third adhesive binder, the third adhesive binder has a weight ratio of VdF and HFP of about 95:5 to about 50:50 and includes a C═O functional group of a (meth)acrylic acid monomer, and the adhesive layer includes about 10 to about 40 wt % of the first adhesive binder; about 30 to about 80 wt % of the second adhesive binder; and about 10 to about 40 wt % of the third adhesive binder, all wt % being based on a total weight of the adhesive layer.

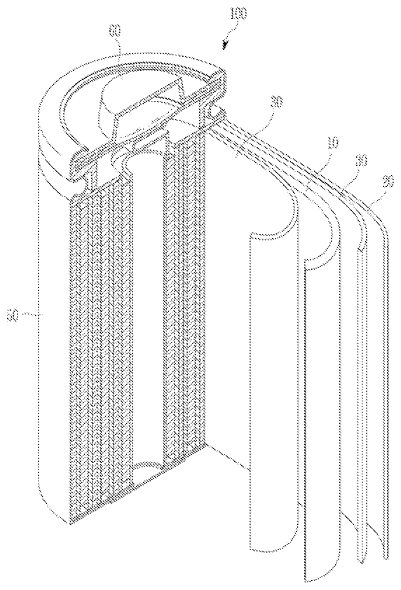

### CROSS-REFERENCE TO RELATED APPLICATION

This application claims priority to and the benefit of Korean Patent Application No. 10-2023-0091251 filed in the Korean Intellectual Property Office on Jul. 13, 2023, the entire contents of which are incorporated herein by reference.

### BACKGROUND

### 1. Field

Embodiments relate to a separator for a rechargeable lithium battery and a rechargeable lithium battery including the same.

### 2. Description of the Related Art

Recently, with the rapid spread of electronic devices that use batteries, such as mobile phones, laptop computers, and electric vehicles, the demand for rechargeable batteries with high energy density and high capacity is rapidly increasing. Accordingly, research and development to improve the performance of rechargeable lithium batteries is actively underway.

A rechargeable lithium battery may include a positive electrode and a negative electrode including an active material capable of intercalating and deintercalating lithium ions, and an electrolyte, and electrical energy is produced through oxidation and reduction reactions when lithium ions are intercalated/deintercalated from the positive electrode and negative electrode.

### SUMMARY

The embodiments may be realized by providing a separator for a rechargeable lithium battery, the separator including a substrate; a heat resistant layer on the substrate; and an adhesive layer on the heat resistant layer, wherein the heat resistant layer includes inorganic particles, and a salt-based heat resistant binder, the adhesive layer includes a first adhesive binder including PVdF-acrylate; a PVdF homopolymer second adhesive binder; and a P(VdF-co-HFP) copolymer third adhesive binder, the third adhesive binder has a weight ratio of VdF and HFP of about 95:5 to about 50:50 and includes a C═O functional group of a (meth)acrylic acid monomer, and the adhesive layer includes about 10 to about 40 wt % of the first adhesive binder; about 30 to about 80 wt % of the second adhesive binder; and about 10 to about 40 wt % of the third adhesive binder, all wt % being based on a total weight of the adhesive layer.

The PVdF-acrylate in the first adhesive binder may have an inter-penetrating network polymer (IPN) structure.

The second adhesive binder may include a C═O functional group of a (meth)acrylic acid monomer.

A melting point of the second adhesive binder may be greater than or equal to about 130° C.

The salt-based heat resistant binder may include a first structural unit including a structural unit of a (meth)acrylic acid or (meth)acrylate and a structural unit of a (meth)acrylamide; and a second structural unit of a (meth)acrylamidosulfonic acid or a salt thereof.

The salt-based heat resistant binder may be a poly (acrylic acid-co-acrylamide-co-sodium 2-acrylamido-2-methylpropanesulfonate salt).

The heat resistant layer may further include a swellable binder of core-shell structure.

The inorganic particles may include boehmite, silica (SiO₂), alumina (Al₂O₃), titania (TiO₂), clay, BaSO₄, MgO, Mg(OH)₂, or a combination thereof.

The inorganic particles may have a D50 particle diameter of about 100 to about 700 nm.

The heat resistant layer may include about 70 to about 99 wt % of the inorganic particles, and about 1 to about 30 wt % of the heat resistant binder, all wt % being based on a total weight of the heat resistant layer.

The heat resistant layer and the adhesive layer may be respectively on both surfaces of the substrate.

The embodiments may be realized by providing a rechargeable lithium battery including a positive electrode; a negative electrode; and the separator according to an embodiment between the positive electrode and the negative electrode.

### BRIEF DESCRIPTION OF THE DRAWING

Features will be apparent to those of skill in the art by describing in detail exemplary embodiments with reference to the attached drawing in which:

the FIGURE is schematic view showing a rechargeable lithium battery according to some embodiments.

### DETAILED DESCRIPTION OF THE EMBODIMENTS

Example embodiments will now be described more fully hereinafter with reference to the accompanying drawing; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing FIGURE, the dimensions of layers and regions may be exaggerated for clarity of illustration. It will also be understood that when a layer or element is referred to as being “on” another layer or element, it can be directly on the other layer or element, or intervening layers may also be present. In addition, it will also be understood that when a layer is referred to as being “between” two layers, it can be the only layer between the two layers, or one or more intervening layers may also be present. Like reference numerals refer to like elements throughout.

As used herein, when specific definition is not otherwise provided, the singular may also include the plural. In addition, unless otherwise specified, “A or B” may mean “including A, including B, or including A and B.”

As used herein, “combination thereof” may mean a mixture of constituents, a stack, a composite, a copolymer, an alloy, a blend, and a reaction product.

As used herein, when a definition is not otherwise provided, a particle diameter may be an average particle diameter. This average particle diameter means an average particle diameter (D50), which is a diameter of particles with a cumulative volume of 50 volume % in the particle size distribution. The average particle diameter (D50) can be measured by methods well known to those skilled in the art, for example, by measuring with a particle size analyzer, a transmission electron microscope or scanning electron microscope, or a scanning electron microscope. Alternatively, a dynamic light-scattering measurement device is used to perform a data analysis, and the number of particles is counted for each particle size range. From this, the average particle diameter (D50) value may be easily obtained through a calculation. A laser diffraction method may also be used. When measuring by laser diffraction, more specifically, the particles to be measured are dispersed in a dispersion medium and then introduced into a commercially available laser diffraction particle size measuring device (e.g., MT 3000 available from Microtrac, Ltd.) using ultrasonic waves at about 28 kHz, and after irradiation with an output of 60 W, the average particle diameter (D50) based on 50% of the particle size distribution in the measuring device can be calculated.

As used herein, when specific definition is not otherwise provided, “alkyl group” refers to a C1 to C20 alkyl group, “alkenyl group” refers to a C2 to C20 alkenyl group, “cycloalkenyl group” refers to a C3 to C20 cycloalkenyl group, “heterocycloalkenyl group” refers to a C3 to C20 heterocycloalkenyl group, “aryl group” refers to a C6 to C20 aryl group, “arylalkyl group” refers to a C6 to C20 arylalkyl group, “alkylene group” refers to a C1 to C20 alkylene group, “arylene group” refers to a C6 to C20 arylene group, “alkylarylene group” refers to a C6 to C20 alkylarylene group, “heteroarylene group” refers to a C3 to C20 heteroarylene group, and “alkoxylene group” refers to a C1 to C20 alkoxylene group.

As used herein, when specific definition is not otherwise provided, “substituted” refers to replacement of at least one hydrogen atom by a substituent selected from a halogen atom (F, Cl, Br, or I), a hydroxy group, a C1 to C20 alkoxy group, a nitro group, a cyano group, an amine group, an imino group, an azido group, an amidino group, a hydrazino group, a hydrazono group, a carbonyl group, a carbamyl group, a thiol group, an ester group, an ether group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C20 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, a C3 to C20 heteroaryl group, or a combination thereof.

As used herein, when specific definition is not otherwise provided, “hetero” refers to inclusion of at least one heteroatom of N, O, S, and P in chemical formulas.

As used herein, when specific definition is not otherwise provided, “(meth)acrylate” refers to both “acrylate” and “methacrylate”, and “(meth)acrylic acid” refers to “acrylic acid” and “methacrylic acid”.

As used herein, when specific definition is not otherwise provided, the term “combination” refers to mixing or copolymerization.

In chemical formulas of the present specification, unless a specific definition is otherwise provided, hydrogen is bonded at the position when a chemical bond is not drawn where supposed to be given.

As used herein, a weight average molecular weight (Mw) may be a value measured using gel permeation chromatography (GPC).

### (Separator)

Some embodiments may provide a separator for a rechargeable lithium battery including, e.g., a substrate; a heat resistant layer on the substrate; and an adhesive layer on the heat resistant layer. In an implementation, the heat resistant layer may include inorganic particles, and a salt-based heat resistant binder. In an implementation, the adhesive layer may include a first adhesive binder including PVdF-acrylate; PVdF homopolymer second adhesive binder; and a P(VdF-co-HFP) copolymer third adhesive binder. In an implementation, the third adhesive binder may have a weight ratio of VdF and HFP of about 95:5 to about 50:50 and may include a C═O functional group of a (meth)acrylic acid monomer. In an implementation, the adhesive layer may include, based on a total weight of the adhesive layer, about 10 to about 40 wt % of the first adhesive binder; about 30 to about 80 wt % of the second adhesive binder; and about 10 to about 40 wt % of the third adhesive binder.

The separator according to some embodiments may help simultaneously secure heat resistance and adhesion, thereby improving cycle-life characteristics of a rechargeable lithium battery at ambient temperature or high temperature.

Hereinafter, the separator of some embodiments will be described in more detail.

### [Adhesive Layer]

The adhesive layer may include, e.g., a first adhesive binder including PVdF-acrylate; a PVdF homopolymer second adhesive binder; and a P(VdF-co-HFP) copolymer third adhesive binder.

### First Adhesive Binder

The PVdF-acrylate may be a binder having an IPN (inter-penetrating network polymer) structure. The IPN structure of the first adhesive binder including PVdF-acrylate may be advantageous for cell cycle-life by minimizing pore clogging compared to acrylate monomers, and may exhibit excellent adhesion compared to PVdF monomers.

The first adhesive binder may have a weight average molecular weight (Mw) of, e.g., about 300,000 to about 1,000,000 g/mol as measured by GPC method.

### Second Adhesive Binder

The second adhesive binder may be a PVdF homopolymer including a C═O functional group of a (meth)acrylic acid monomer. This may have a stronger interaction with the positive or negative electrode plate compared to a PVdF homopolymer that does not include a C═O functional group of a (meth)acrylic acid monomer.

The melting point (Tm) of the second adhesive binder may be, e.g., greater than or equal to about 130° C. In an implementation, the Tm may be, e.g., less than or equal to about 200° C. In this case, the spherical shape may be maintained and pores secured even under the pressurized conditions of the rechargeable lithium battery cell.

The second adhesive binder may have a weight average molecular weight (Mw) of, e.g., about 300,000 to about 1,000,000 g/mol as measured by GPC method.

### Third Adhesive Binder

The third adhesive binder may be a P(VdF-co-HFP) copolymer including a C═O functional group of a (meth)acrylic acid monomer. This may have a stronger interaction with the positive or negative electrode plate compared to a P(VdF-co-HFP) copolymer that does not include a C═O functional group of a (meth)acrylic acid monomer.

The third adhesive binder may have a mole ratio of VdF and HFP of about 95:5 to about 50:50, e.g., about 90:10 to about 75:25. Within the above ranges, if the electrolyte solution is impregnated with the third binder, it may swell and increase adhesion to the positive or negative electrode plate. If the above ranges are not satisfied, less swelling could occur, and the adhesion with the positive or negative electrode plate could be weakened.

The third adhesive binder may have a weight average molecular weight (Mw) of, e.g., about 100,000 to about 1,000,000 g/mol as measured by GPC method.

### Composition of the Adhesive Layer

The adhesive layer may include about 10 to about 40 wt %, e.g., about 15 to about 30 wt % of the first adhesive binder; about 30 to about 80 wt %, e.g., about 40 to about 70 wt % of the second adhesive binder; and about 10 to about 40 wt %, e.g., 15 to 30 wt % of the third adhesive binder, based on a total weight of the adhesive layer. Within these ranges, high adhesion to the positive or negative electrode plate and stability of cycle-life of the rechargeable lithium battery cell may be expected. If these ranges were not satisfied, rechargeable lithium battery cell characteristics could deteriorate due to increased resistance.

### Thickness of Adhesive Layer

A thickness of the adhesive layer may be, e.g., about 0.5 to about 3.0 μm, about 1 to about 2 μm, or about 1.5 to about 2 μm.

Within the above ranges, the separator of some embodiments may exhibit excellent heat resistance.

### [Heat Resistant Layer]

The heat resistant layer may include inorganic particles and a salt-based heat resistant binder.

### Inorganic Particles

The inorganic particles may be highly heat-resistant and may include ceramics.

The inorganic particles may include, e.g., boehmite, silica (SiO₂), alumina (Al₂O₃), titania (TiO₂), clay, BaSO₄, MgO, Mg(OH)₂, or a combination thereof. In an implementation, the inorganic particles may be boehmite, which makes it easy to control the D50 particle diameter and shape.

The inorganic particles may have a D50 particle diameter of about 100 to about 500 nm, e.g., about 200 to about 400 nm, or about 250 to about 350 nm.

### Salt-based Heat Resistant Binder

The salt-based heat resistant binder is a binder with high heat resistance and may include an acrylic salt-based binder including nitrogen (N).

The salt-based heat resistant binder may include a first structural unit of a (meth)acrylic acid or a (meth)acrylate and a structural unit of a (meth)acrylamide; and a second structural unit of a (meth)acrylamidosulfonic acid or a salt thereof.

The structural unit of a (meth)acrylic acid or (meth)acrylate may be represented by, e.g., one of Chemical Formula 1, Chemical Formula 2, Chemical Formula 3, and a combination thereof.

The structural unit of a (meth)acrylamide may be represented by Chemical Formula 4.

The second structural unit of a (meth)acrylamidosulfonic acid or the salt thereof may be represented by, e.g., one of Chemical Formula 5, Chemical Formula 6, Chemical Formula 7, and a combination thereof.

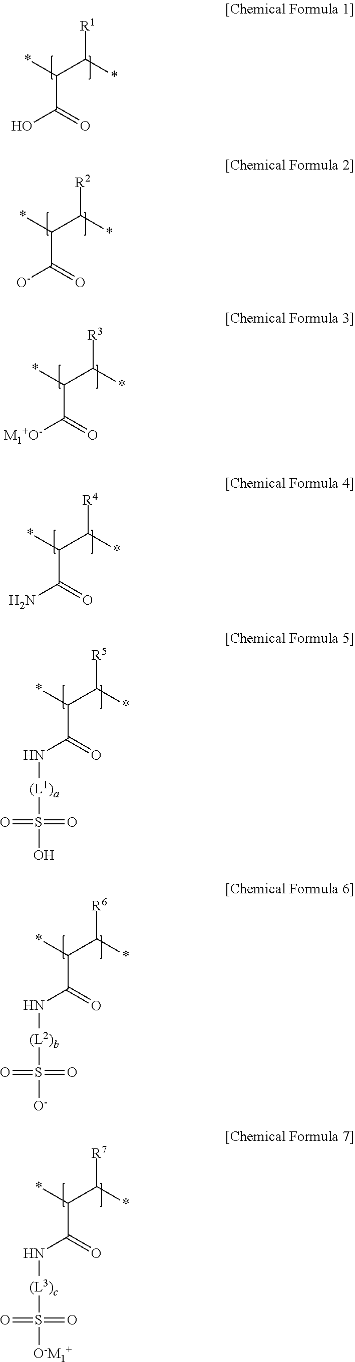

The descriptions of Chemical Formulas 1 to 7 are as follows:

R¹ to R⁷ may each independently be or include, e.g., hydrogen or a substituted or unsubstituted C1 to C6 alkyl group. In an implementation, R¹ to R⁷ may all be hydrogen.

L¹ to L³ may each independently be or include, e.g., a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group. In an implementation, L¹ to L³ may all be *—C(CH₃)₂—CH₂—*

M₁ may be an alkali metal. The alkali metal may be, e.g., lithium, sodium, potassium, rubidium, or cesium. In an implementation, the metal may be lithium or sodium.

a, b, and c may each independently be integers of 0 to 2. In an implementation, a, b, and c may all be 1.

The structural unit of a (meth)acrylic acid or (meth)acrylate may include, respectively, or together, the structural unit represented by Chemical Formula 1 and the structural unit represented by Chemical Formula 2. In the latter case, the structural unit of a (meth)acrylic acid or (meth)acrylate may include the structural unit represented by Chemical Formula 1 and the structural unit represented by Chemical Formula 2 in a mole ratio of about 1:10 to about 2:1, about 1:5 to about 1:1, or about 1:1 to about 1:3.

The structural unit of a (meth)acrylamidosulfonic acid or the salt thereof may include, respectively, or together, the structural unit represented by Chemical Formula 5 and the structural unit represented by Chemical Formula 7. In the latter case, the structural unit of a (meth)acrylamidosulfonic acid or the salt thereof may include the structural unit represented by Chemical Formula 5 and the structural unit represented by Chemical Formula 7 in a mole ratio of about 1:10 to about 2:1, about 1:5 to about 1:1, or about 1:1 to about 1:3.

Based on 100 mol % of the salt-based heat resistant binder, the first structural unit may be included in an amount of greater than or equal to about 90 mol % and less than about 100 mol %, or greater than or equal to about 95 mol % and less than about 100 mol %; and the second structural unit may be included in an amount of greater than about 0 mol % and less than or equal to about 10 mol %, or greater than about 0 mol % and less than or equal to about 5 mol %.

In an implementation, the salt-based heat resistant binder may include a moiety represented by Chemical Formula 8.

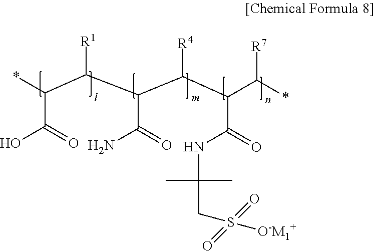

In Chemical Formula 8, M₁ may be an alkali metal. The alkali metal may be lithium, sodium, potassium, rubidium, or cesium, e.g., lithium or sodium.

l, m, and n mean a mole ratio of each unit, 0.9≤(l+m)<1, and 0<n≤0.1, and l+m+n=1. In an implementation, 00≤1≤0.4, 0.55≤m≤0.95, and 0≤n≤0.1. In an implementation, 0<1≤0.05, 0.95≤m≤0.95, and 0<n≤0.05.

In an implementation, the salt-based heat resistant binder represented by Chemical Formula 8 may be a poly (acrylic acid-co-acrylamide-co-sodium 2-acrylamido-2-methylpropanesulfonate salt).

The salt-based heat resistant binder may be prepared by various suitable methods such as emulsion polymerization, suspension polymerization, bulk polymerization, solution polymerization, or bulk polymerization.

Swellable Binder with Core-shell Structure

In an implementation, the heat resistant layer may further include a swellable binder with a core-shell structure.

The swellable binder with the core-shell structure may be a binder that includes a structural unit of a vinyl aromatic compound, a structural unit of an aliphatic acrylate compound, and a structural unit of a phosphonate acrylate compound.

The swellable binder with the core-shell structure may have a glass transition temperature (Tg) of about 60 to about 120° C., and may expand about 2 to about 1,000 times compared to its initial volume when impregnated with an electrolyte solution.

In an implementation, the swellable binder with the core-shell structure may be further included, and a weight ratio of the salt-based heat resistant binder and the swellable binder with the core-shell structure may be, e.g., about 1:99 to about 99:1, about 50:50 to about 99:1, or about 70:30 to about 99:1.

### Composition of Heat Resistant Layer

The heat resistant layer may include, e.g., about 70 to about 99 wt %, about 80 to about 99 wt %, or about 90 to about 99 wt % of the inorganic particles, based on a total weight of the heat resistant layer.

The heat resistant layer may include, e.g., about 1 to about 30 wt %, about 1 to about 20 wt %, or about 1 to about 10 wt % of the heat resistant binder, based on a total weight of the heat resistant layer.

Within the above ranges, the separator of some embodiments may exhibit excellent heat resistance.

### Single-surface Coating or Both-surfaces Coating

In an implementation, the heat resistant layer and the adhesive layer may each independently be coated on one surface or both (e.g., two) surfaces.

In an implementation, both the heat resistant layer and the adhesive layer may be on both surfaces of the substrate. In this case, it may be advantageous to simultaneously secure the heat resistance and adhesion of the separator.

### Substrate

The substrate may be a porous substrate.

The porous substrate may be a polymer film formed of a polymer, or a copolymer or mixture of two or more of polyolefin such as polyethylene or polypropylene, a polyester such as polyethyleneterephthalate, or polybutyleneterephthalate, polyacetal, polyamide, polyimide, polycarbonate, polyether ketone, polyaryl ether ketone, polyether imide, polyamideimide, polybenzimidazole, polyether sulfone, polyphenylene oxide, a cyclic olefin copolymer, polyphenylene sulfide, polyethylene naphthalate, a glass fiber, TEFLON (tetrafluoroethylene), or polytetrafluoroethylene.

In an implementation, the porous substrate may be a polyolefin substrate containing polyolefin, and the polyolefin substrate may have an excellent shutdown function, which may help contribute to improving the safety of the battery. The polyolefin substrate may include, e.g., a polyethylene single film, a polypropylene single film, a polyethylene/polypropylene double film, a polypropylene/polyethylene/polypropylene triple film, or a polyethylene/polypropylene/polyethylene triple film. In an implementation, the polyolefin resin may include a non-olefin resin in addition to an olefin resin, or may include a copolymer of olefin and non-olefin monomer.

The porous substrate may have a thickness of about 1 μm to about 40 μm, e.g., about 1 μm to about 30 μm, about 1 μm to about 20 μm, about 5 μm to about 20 μm, about 5 μm to about 15 μm, or about 5 μm to about 10 μm.

### Manufacturing Method

A separator for a rechargeable lithium battery according to some embodiments may be manufactured by various suitable methods. In an implementation, a separator for a rechargeable lithium battery may be formed by applying a composition for forming each layer to one or both surfaces of a porous substrate and then drying it.

The coating may include, e.g., spin coating, dip coating, bar coating, die coating, slit coating, roll coating, inkjet printing, or the like.

The drying may be, e.g., performed through natural drying, drying with warm air, hot air, or low humid air, vacuum-drying, or radiation of a far-infrared ray, an electron beam, or the like. The drying process may be performed at a temperature of, e.g., about 25° C. to about 120° C.

The separator for a rechargeable lithium battery may be manufactured by lamination, coextrusion, or the like, in addition to the above methods.

### (Rechargeable Lithium Battery)

Some embodiments provide a rechargeable lithium battery including the aforementioned separator for a rechargeable lithium battery.

### Positive Electrode Active Material

The positive electrode active material may be a compound (lithiated intercalation compound) capable of intercalating and deintercalating lithium. In an implementation, one or more types of composite oxides of lithium and a metal, e.g., cobalt, manganese, nickel, or combinations thereof, may be used.

The composite oxide may be a lithium transition metal composite oxide, e.g., a lithium nickel oxide, lithium cobalt oxide, lithium manganese oxide, a lithium iron phosphate compound, cobalt-free lithium nickel-manganese oxide, or a combination thereof.

In an implementation, a compound represented by one of the following chemical formulas may be used. LiₐA_{1-b}X_{b}O_{2-c}D′_{c} (0.90≤a≤1.8, 0≤b≤0.5, 0≤c≤0.05); LiₐMn_{2-b}X_{b}O_{4-c}D′_{c} (0.90<a≤1.8, 0≤b≤0.5, 0≤b≤0.05); LiₐNi_{1-b-c}Co_{b}X_{c}O_{2-α}D′_{α} (0.90<a≤1.8, 0<b<0.5, 0≤c≤0.5, 0<α<2); LiₐNi_{1-b-c}Mn_{b}X_{c}O_{2-α}D′_{α} (0.90≤a≤1.8, 0≤b≤0.5, 0≤c≤0.5, 0<α<2); LiₐNi_{b}Co_{c}L¹_{d}G_{c}O₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃(0≤f≤2); LiₐFePO₄ (0.90≤a≤1.8).

In the above chemical formulas, A may be, e.g., Ni, Co, Mn, or a combination thereof; X may be, e.g., Al, Ni, Co, Mn, Cr, Fe, Mg, Sr, V, a rare earth element, or a combination thereof; D′ may be, e.g., O, F, S, P, or a combination thereof; G may be, e.g., Al, Cr, Mn, Fe, Mg, La, Ce, Sr, V, or a combination thereof; and L¹ may be, e.g., Mn, Al, or a combination thereof.

### Positive Electrode

The positive electrode for a rechargeable lithium battery may include a current collector and a positive electrode active material layer on the current collector. The positive electrode active material layer may include a positive electrode active material and may further include a binder and/or a conductive material.

For example, the positive electrode may further include an additive that can function as a sacrificial positive electrode.

A content of the positive electrode active material may be about 90 wt % to about 99.5 wt %, and a content of the binder and the conductive material may be about 0.5 wt % to about 5 wt %, respectively based on 100 wt % of the positive electrode active material layer.

The binder may help attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like.

The conductive material may help impart conductivity (e.g., electrical conductivity) to the electrode. A suitable material that does not cause chemical change (e.g., does not cause an undesirable chemical change in the rechargeable lithium battery) and conducts electrons may be used in the battery. Examples of the conductive material may include a carbon material such as natural graphite, artificial graphite, carbon black, acetylene black, ketjen black, a carbon fiber, a carbon nanofiber, or carbon nanotube; a metal material including copper, nickel, aluminum, silver, or the like, in a form of a metal powder or a metal fiber; a conductive polymer such as a polyphenylene derivative; or a mixture thereof.

In an implementation, Al may be used as the current collector.

### Negative Electrode Active Material

The negative electrode active material may be a material that reversibly intercalates/deintercalates lithium ions, a lithium metal, a lithium metal alloy, a material capable of doping and dedoping lithium, or a transition metal oxide.

The material that reversibly intercalates/deintercalates lithium ions may include a carbon negative electrode active material, e.g., crystalline carbon, amorphous carbon, or a combination thereof. The crystalline carbon may be graphite such as irregular, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy may include lithium and a metal, e.g., Na, K, Rb, Cs, Fr, Be, Mg, Ca, Sr, Si, Sb, Pb, In, Zn, Ba, Ra, Ge, Al, or Sn.

The material capable of doping/dedoping lithium may be a Si negative electrode active material or a Sn negative electrode active material. The Si negative electrode active material may include silicon, a silicon-carbon composite, SiOₓ (0<x<2), a Si-Q alloy (wherein Q is an alkali metal, an alkaline-earth metal, a Group 13 element, a Group 14 element (excluding Si), a Group 15 element, a Group 16 element, a transition metal, a rare earth element, or a combination thereof). The Sn negative electrode active material may include Sn, SnO₂, a Sn-based alloy, or a combination thereof.

The silicon-carbon composite may be a composite of silicon and amorphous carbon. In an implementation, the silicon-carbon composite may be in a form of silicon particles and amorphous carbon coated on the surface of the silicon particles. In an implementation, the silicon-carbon composite may include a secondary particle (core) in which primary silicon particles are assembled, and an amorphous carbon coating layer (shell) on the surface of the secondary particle. The amorphous carbon may also be between the primary silicon particles, and, e.g., the primary silicon particles may be coated with the amorphous carbon. The secondary particle may exist dispersed in an amorphous carbon matrix.

The silicon-carbon composite may further include crystalline carbon. In an implementation, the silicon-carbon composite may include a core including crystalline carbon and silicon particles and an amorphous carbon coating layer on a surface of the core.

The Si negative electrode active material or the Sn negative electrode active material may be used in combination with a carbon negative electrode active material.

### Negative Electrode

A negative electrode for a rechargeable lithium battery may include a current collector and a negative electrode active material layer on the current collector. The negative electrode active material layer may include a negative electrode active material and may further include a binder or a conductive material.

In an implementation, the negative electrode active material layer may include about 90 wt % to about 99 wt % of the negative electrode active material, about 0.5 wt % to about 5 wt % of the binder, and about 0.5 wt % to about 5 wt % of the conductive material.

The binder may help attach the negative electrode active material particles well to each other and also to attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrin, polyphosphazene, poly (meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

In an implementation, an aqueous binder may be used as the negative electrode binder, and it may further include a cellulose compound capable of imparting viscosity. The cellulose compound may include, e.g., carboxymethyl cellulose, hydroxypropylmethyl cellulose, methyl cellulose, or alkali metal salts thereof. The alkali metal may include Na, K, or Li.

The dry binder may be a polymer material capable of being fiberized, and may include, e.g., polytetrafluoroethylene, polyvinylidene fluoride, polyvinylidene fluoride-hexafluoropropylene copolymer, polyethylene oxide, or a combination thereof.

The conductive material may be included to provide electrode conductivity, and a suitable electrically conductive material may be used as a conductive material unless it causes a chemical change. Examples of the conductive material may include a carbon material such as natural graphite, artificial graphite, carbon black, acetylene black, ketjen black, a carbon fiber, a carbon nanofiber, a carbon nanotube, or the like; a metal material such as copper, nickel, aluminum silver, or the like in a form of a metal powder or a metal fiber; a conductive polymer such as a polyphenylene derivative; or a mixture thereof.

The negative electrode current collector may include a copper foil, a nickel foil, a stainless steel foil, a titanium foil, a nickel foam, a copper foam, a polymer substrate coated with a conductive metal, or a combination thereof.

### Electrolyte Solution

The electrolyte solution for a rechargeable lithium battery may include a non-aqueous organic solvent and a lithium salt.

The non-aqueous organic solvent may serve as a medium for transmitting ions taking part in the electrochemical reaction of a battery.

The non-aqueous organic solvent may include, e.g., a carbonate solvent, ester solvent, ether solvent, ketone solvent, alcohol solvent, aprotic solvent, or a combination thereof.

The carbonate solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include methyl acetate, ethyl acetate, n-propyl acetate, dimethylacetate, methylpropionate, ethylpropionate, decanolide, mevalonolactone, valerolactone (valerolactone), caprolactone, or the like. The ether solvent may include dibutyl ether, tetraglyme, diglyme, dimethoxyethane, 2-methyltetrahydrofuran, 2,5-dimethyltetrahydrofuran, or tetrahydrofuran. The ketone solvent may include cyclohexanone. The alcohol solvent may include ethyl alcohol, isopropyl alcohol, or the like. The aprotic solvent may include nitriles such as R—CN (wherein R is a C2 to C20 linear, branched, or cyclic hydrocarbon group, a double bond, an aromatic ring, or an ether group), amides such as dimethylformamide, dioxolanes such as 1,3-dioxolane or 1,4-dioxolane, sulfolanes, or the like.

The non-aqueous organic solvent may be used alone or in combination of two or more.

In an implementation, a carbonate solvent may be used, a cyclic carbonate and chain carbonate may be mixed and used, and the cyclic carbonate and chain carbonate can be mixed at a volume ratio of about 1:1 to about 1:9.

The lithium salt dissolved in the organic solvent may supply lithium ions in a battery, enables a basic operation of a rechargeable lithium battery, and improves transportation of the lithium ions between positive and negative electrodes. Examples of a lithium salt may include LiPF₆, LiBF₄, LiSbF₆, LiAsF₆, LiClO₄, LiAlO₂, LiAlCl₄, LiPO₂F₂, LiCl, LiI, LiN (SO₃C₂F₅)₂, Li(FSO₂)₂N (lithium bis(fluorosulfonyl)imide (LiFSI), LiC₄F₉SO₃, LiN(CₓF₂ₓ₊₁SO₂)(C_{y}F_{2y+1}SO₂) (x and y are integers from 1 to 20), lithium trifluoromethane sulfonate, lithium tetrafluoroethanesulfonate, lithium difluorobis (oxalato) phosphate, (LiDFOB), and lithium bis (oxalato) borate (LiBOB).

### Rechargeable Lithium Battery

The rechargeable lithium battery may be classified into, e.g., cylindrical, prismatic, pouch, coin-type batteries, or the like depending on their shape. The FIGURE is schematic view illustrating a rechargeable lithium battery according to some embodiments and shows a cylindrical battery. Referring to the FIGURE, the rechargeable lithium battery 100 may include an electrode assembly including a separator 30 between a positive electrode 10 and a negative electrode 20, and a case 50 in which the electrode assembly is housed, with a sealing member 60 thereon. The positive electrode 10, the negative electrode 20, and the separator 30 may be impregnated with an electrolyte.

The rechargeable lithium battery according to some embodiments may be applied to automobiles, mobile phones, or various types of electrical devices.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### PREPARATION EXAMPLES

### Preparation Example 1: Preparation of Salt-based Heat Resistant Binder

In a 10 L four-necked flask equipped with a stirrer, a thermometer, and a cooling tube, after adding distilled water (6,361 g), acrylic acid (72.06 g, 1.0 mol), acrylamide (604.1 g, 8.5 mol), potassium persulfate (2.7 g, 0.01 mol), 2-acrylamido-2-methylpropanesulfonic acid (103.6 g, 0.5 mol), and 5 N sodium hydroxide aqueous solution (1.05 equivalents based on the total amount of 2-acrylamido-2-methylpropanesulfonic acid), an operation of reducing an internal pressure to 10 mmHg with diaphragm pump and returning the internal pressure to normal pressure with nitrogen, was repeated three times.

While controlling the temperature of reaction solution so as to be stable between 65° C. to 70° C., the reaction is conducted for 12 hours. After cooling to ambient temperature, the pH of the reaction solution was adjusted to 7 to 8 using a 25% aqueous ammonia solution.

The poly (acrylic acid-co-acrylamide-co-sodium 2-acrylamido-2-methylpropanesulfonate salt) was prepared in this manner.

Herein, the mole ratio of the structural unit of acrylic acid, the structural unit of acrylamide, and the structural unit of 2-acrylamido-2-methylpropanesulfonic acid is 10:85:5.

About 10 mL of the reaction solution (reaction product) was taken and the measurement result of the non-volatile component is 9.5% (theoretical value: 10%).

### Preparation Example 2: Preparation of First Adhesive Binder

A PVdF-acrylate copolymer with an IPN structure, including an acrylate crosslinked polymer and a vinylidene fluoride crosslinked polymer in a weight ratio of 3:7, and a polymer with a total weight average molecular weight of 500,000 g/mol (product name: LBG4330LX, manufacturer: Arkema) was prepared.

### Preparation Example 3: Preparation of Second Adhesive Binder

PVdF homopolymer particles (product name: Solef latex 2062, manufacturer: Solvay) with a D50 particle diameter of 250 nm and a weight average molecular weight of 500,000 g/mol were prepared.

### Preparation Example 4: Preparation of Third Adhesive Binder

13.5 L of deionized water was introduced into a 21 L horizontal reactor autoclave equipped with a stirrer and baffles operating at 50 rpm. The temperature was set to 80° C. and a pressure of 35 Bar was maintained constant throughout the entire test by supplying a gaseous mixture monomer of VDF/HFP at a mole ratio of 99:1, respectively. After adding 250 ml of an ammonium persulfate (APS) aqueous solution (100 g/l) thereto over 15 minutes (1L/h), an ammonium persulfate (APS) solution was continuously added at a flux rate of 60 ml/h during the total duration of this test; in addition, 50 ml of an acrylic acid (AA) solution (50 g/l of acrylic acid in water) was supplied for every 250 g of the consumed monomer. When 4,500 g of the mixture was supplied, the supply of the mixture was stopped, and subsequently, the pressure was lowered to a maximum of 12 bar, while constantly maintaining the reaction temperature. A final reaction time was 223 minutes. The reactor was cooled to ambient temperature to recover a latex. The obtained polymer had a D50 particle diameter of 180 nm to 300 nm and a VdF: HFP weight ratio of 90:10 and included a C═O functional group by containing the acrylic acid (AA) monomer.

### Preparation Example 5: Preparation of Third Adhesive Binder

A third adhesive binder was prepared in the same manner as in Preparation Example 4 except that the VdF: HFP weight ratio was 85:15.

### Preparation Example 6: Preparation of Third Adhesive Binder

A third adhesive binder was prepared in the same manner as in Preparation Example 4 except that the VdF: HFP weight ratio was 75:25.

### Comparative Preparation Example 1: Preparation of Third Adhesive Binder

A third adhesive binder was prepared in the same manner as in Preparation Example 4 except that the VdF: HFP weight ratio was 82:18, and the C═O functional group was not included.

### Comparative Preparation Example 2: Preparation of Third Adhesive Binder

A third adhesive binder was prepared in the same manner as in Preparation Example 4 except that the VdF: HFP weight ratio was 97:3.

### Comparative Preparation Example 3: Preparation of First Adhesive Binder

An acrylate-type latex having a D50 particle diameter of 500 nm and Tg of 54° C. (Product name: BM-2580M, Manufacturer: Zeon) was prepared.

### EXAMPLES

### Example 1

### (1) Formation of Heat Resistant Layer

Boehmite having a D50 particle diameter of 300 nm (Nabaltec AG, Japan) was pulverized by using a bead mill for 2 hours to obtain inorganic dispersion including 40 wt % of the boehmite (60 wt % of water). Subsequently, the inorganic dispersion was mixed with the heat resistant binder of Preparation Example 1 to have a boehmite content of 95%, and a composition for forming a heat resistant layer was prepared by adding water thereto to adjust a total solid content to 25 wt %.

The composition for forming a heat resistant layer was Gravure-coated on the cross-section of a 5.5 μm-thick polyethylene single film as a substrate and dried at 70° C. for 10 seconds at a wind speed of 15 m/sec to form a 2 μm-thick heat resistant layer.

### (2) Formation of Adhesive Layer

A composition for an adhesive layer was prepared by mixing the first adhesive binder of Preparation Example 2, the second adhesive binder of Preparation Example 3, and the third adhesive binder of Preparation Example 4 in a weight ratio of 25:50: 25and adding 2 wt % of a PAA compound (AQC, Sumittomo Corp.) based on a total weight of the composition thereto.

The composition for an adhesive layer was coated on both surfaces of the separator, on which the heat resistant layer was formed, to form an adhesive coating layer having a loading amount of 1.0 g/m² per each surface.

### (3) Manufacture of Rechargeable Lithium Battery Cells

LiCoO₂ as a positive electrode active material, polyvinylidene fluoride as a binder, and carbon as a conductive material were mixed in a weight ratio of 92:4:4, and then, dispersed in N-methyl-2-pyrrolidone to prepare positive electrode slurry. The slurry was coated on a 20 μm-thick Al foil, dried, and compressed to manufacture a positive electrode.

Artificial graphite as a negative electrode active material, a styrene-butadiene rubber as a binder and carboxymethyl cellulose as a thickener in a weight ratio of 96:2:2 were dispersed in distilled water to prepare negative electrode active material slurry. The slurry was coated on a 15 μm-thick, dried, and compressed to manufacture a negative electrode.

A cylindrical battery cell was manufactured using the positive electrode, negative electrode, and separator. The electrolyte solution was a 1.3 M LiPF₆ solution in a mixed solvent of ethyl carbonate (EC)/ethylmethyl carbonate (EMC)/diethyl carbonate (DEC) (volume ratio of 3/5/2).

### Example 2

A rechargeable lithium battery cell was manufactured in the same manner as in Example 1 except that the third adhesive binder of Preparation Example 5 was used instead of the third adhesive binder of Preparation Example 4.

### Example 3

A rechargeable lithium battery cell was manufactured in the same manner as in Example 1 except that the third adhesive binder of Preparation Example 6 was used instead of the third adhesive binder of Preparation Example 4.

### Example 4

A rechargeable lithium battery cell was manufactured in the same manner as in Example 1 except that the first adhesive binder of Preparation Example 2, the second adhesive binder of Preparation Example 3, and the third adhesive binder of Preparation Example 4 were mixed in a weight ratio of 30:40:30.

### Example 5

A rechargeable lithium battery cell was manufactured in the same manner as in Example 1 except that the first adhesive binder of Preparation Example 2, the second adhesive binder of Preparation Example 3, and the third adhesive binder of Preparation Example 4 were mixed in a weight ratio of 15:70:15.

### COMPARATIVE EXAMPLES

### Comparative Example 1

A rechargeable lithium battery cell was manufactured in the same manner as in Example 1 except that the first adhesive binder of Preparation Example 2, the second adhesive binder of Preparation Example 3, and the third adhesive binder of Preparation Example 4 were mixed in a weight ratio of 50:50:0.

### Comparative Example 2

A rechargeable lithium battery cell was manufactured in the same manner as in Example 1 except that the third adhesive binder of Comparative Preparation Example 1 was used instead of the third adhesive binder of Preparation Example 4.

### Comparative Example 3

A rechargeable lithium battery cell was manufactured in the same manner as in Example 1 except that the third adhesive binder of Comparative Preparation Example 2 was used instead of the third adhesive binder of Preparation Example 4.

### Comparative Example 4

A rechargeable lithium battery cell was manufactured in the same manner as in Example 1 except that the third adhesive binder of Comparative Preparation Example 1 was used instead of the third adhesive binder of Preparation Example 3.

### Comparative Example 5

A rechargeable lithium battery cell was manufactured in the same manner as in Example 1 except that the third adhesive binder of Comparative Preparation Example 3 was used instead of the third adhesive binder of Preparation Example 2

### Comparative Example 6

A rechargeable lithium battery cell was manufactured in the same manner as in Example 1 except that the first adhesive binder of Preparation Example 2, the second adhesive binder of Preparation Example 3, and the third adhesive binder of Preparation Example 4 were mixed in a weight ratio of 45:10:45.

### Comparative Example 7

A rechargeable lithium battery cell was manufactured in the same manner as in Example 1 except that the first adhesive binder of Preparation Example 2, the second adhesive binder of Preparation Example 3, and the third adhesive binder of Preparation Example 4 were mixed in a weight ratio of 5:90:5.

The adhesive layers of the Examples and the Comparative Examples are summarized in Tables 1 and 2.

TABLE 1

| | | Examples | | | | |
|---|---|---|---|---|---|---|
| | | 1 | 2 | 3 | 4 | 5 |
| First | PVdF-Acrylate | 25 | 25 | 25 | 30 | 15 |
| adhesive | Acylate latex | — | — | — | — | — |
| binder | | | | | | |
| Second | PVdF homopolymer | 50 | 50 | 50 | 40 | 70 |
| adhesive | (homo PVdF) | | | | | |
| binder | | | | | | |
| Third | PVdF-HFP co-polymer | 25 | — | — | 30 | 15 |
| adhesive | HFP 10 wt %, having C═O | | | | | |
| binder | PVdF-HFP co-polymer | — | 25 | — | — | — |
| | HFP 15 wt %, having C═O | | | | | |
| | PVdF-HFP co-polymer | — | — | 25 | — | — |
| | HFP 25 wt %, having C═O | | | | | |
| | PVdF-HFP co-polymer | — | — | — | — | — |
| | HFP 18 wt %, not having C═O | | | | | |
| | PVdF-HFP co-polymer | — | — | — | — | — |
| | HFP 3 wt %, not having C═O | | | | | |

TABLE 2

| | | Comparative Examples | | | | | | |
|---|---|---|---|---|---|---|---|---|
| | | 1 | 2 | 3 | 4 | 5 | 6 | 7 |
| First | PVdF-Acrylate | 50 | 25 | 25 | 25 | — | 45 | 5 |
| adhesive | Acylate latex | — | — | — | — | 25 | — | — |
| binder | | | | | | | | |
| Second | PVdF homopolymer | 50 | 50 | 50 | — | 50 | 10 | 90 |
| adhesive | (homo PVdF) | | | | | | | |
| binder | | | | | | | | |
| Third | PVdF-HFP co-polymer | — | — | — | 25 | 25 | 45 | 5 |
| adhesive | HFP 10 wt %, having C═O | | | | | | | |
| binder | PVdF-HFP co-polymer | — | — | — | — | — | — | — |
| | HFP 15 wt %, having C═O | | | | | | | |
| | PVdF-HFP co-polymer | — | — | — | — | — | — | — |
| | HFP 25 wt %, having C═O | | | | | | | |
| | PVdF-HFP co-polymer | — | 25 | — | — | — | — | — |
| | HFP 18 wt %, not having C═O | | | | | | | |
| | PVdF-HFP co-polymer | — | — | 25 | 50 | — | — | — |
| | HFP 3 wt %, not having C═O | | | | | | | |

### EVALUATION EXAMPLES

### Evaluation Example 1: Separator

### (1) Adhesion

### Separator-Electrode Adhesion When Drying

Each of the separators of the Examples and the Comparative Examples was evaluated with respect to separator-electrode adhesion during the drying, and the results are shown in Table 3.

Each of the separators of the Examples and the Comparative Examples was cut to have a width of 25 mm and a length of 80 mm, and a polyethylene non-woven fabric was cut to have the same size as the separator. Electrodes were cut to have a width of 30 mm and a length of 80 mm. One of the electrodes was disposed on one surface of each of the separators, and on the other surface thereof, a polyethylene non-woven fabric and the other electrode were disposed thereon to manufacture a unit-cell.

The unit-cell was adhered at about 95° C. for 40 sec under 400 kgf/cm. After disassembling the unit-cell to separate the separator from the electrode by about 10 to 20 mm, the separator was mounted and fixed onto an upper grip, while the electrode was mounted and fixed onto a lower grip with a space of 20 mm between the grips, and then, pulled and peeled in a direction of 180°. The peeling was performed at 20 mm/min to three times measure a force (gf/mm) required for 40 mm peeling, and an average thereof was calculated.

Herein, the electrodes were the same as the positive and negative electrodes described in Example 1.

### Adhesion When Wetting

Each of the separators of the Examples and the Comparative Examples was evaluated with respect to separator-electrode adhesion during the wetting, and the results are shown in Table 3.

The same unit-cell as manufactured to evaluate the adhesion during the drying was manufactured, which was performed by injecting an electrolyte solution into a 10 cm×10 cm pouch to immerse the unit-cell in the electrolyte solution and taking it out therefrom and then, adhering it at 80° C. for 1 hour under 300 kgf/cm. Subsequently, a peeling test was performed under the same condition as measured during the drying to three times measure a force (gf/mm) required for the peeling, and an average thereof was calculated.

Herein, the electrodes are the same as the positive and negative electrodes as described in Example 1, and the same electrolyte solution as described in Example 1 is used.

### (2) Change in Air Permeability

(a) Each of the separators of the Examples and the Comparative Examples was cut into a size of 5 cm×5 cm, and a polyethylene non-woven fabric, an aluminum substrate, and a positive electrode were also cut into the same size as the separator. The polyethylene non-woven fabric was disposed on both surfaces of the separator to manufacture a unit-cell, and the unit-cell was measured with respect to air permeability. Each unit-cell was manufactured by 3 in total.

(b) After measuring the air permeability according to (a), the aluminum substrate and the positive electrode were disposed on both surfaces of each unit-cell, and the unit-cell was provided with an electrolyte solution. The electrolyte solution was a 1 M LiBF₄ solution in propylenecarbonate (PC). The corresponding cell was adhered at about 80° C. for 1 hour under 300 kgf/cm. Subsequently, the cell was disassembled to remove the aluminum substrate and the positive electrode, washed with dimethylcarbonate (DMC) for 20 seconds to remove the lithium salt, and dried to measure the air permeability. The air permeability was obtained by measuring time (sec) taken for 100 cc of air to pass through each sample under a constant pressure (0.05 MPa) by using an air permeability meter (Maker: Asahi Seiko, Model: EG01-55-1MR). The air permeability was measured in three unit-cells and then, averaged to obtain a change in air permeability before and after the heat compression, and the results are shown in Table 3.

Change in air permeability=(air permeability after adhesion (b)−air permeability before adhesion (a))

### Evaluation Example 2: Rechargeable Lithium Battery Cells

Each of the separators of the Examples and the Comparative Examples was evaluated with respect to high-temperature cycle-life characteristics in the following method, and the results are shown in Table 3.

The rechargeable lithium battery cells were constant current-charged to 4.25 V at a current rate of 1.0 C and constant voltage-charged to a current of 0.05 C, while maintaining 4.25 V, in a high temperature (45° C.) chamber and then, discharged to a voltage of 2.8 V at a constant current of 1.0 C.

This charge and discharge as one cycle were repeated 300 times to evaluate capacity retention according to Equation 1.

$$Capacity retention rate ( \% ) = ( discharge capacity at 300 th cycle \text{} / discharge capacity at first cycle ) \times 100 \qquad [ Equation 1 ]$$

TABLE 3

| | | Examples | | | | | Comparative Examples | | | | | | |
|---|---|---|---|---|---|---|---|---|---|---|---|---|---|
| | | 1 | 2 | 3 | 4 | 5 | 1 | 2 | 3 | 4 | 5 | 6 | 7 |
| Drying | Adhesion of | 0.3 | 0.4 | 0.5 | 0.5 | 0.3 | 0.3 | 0.4 | 0.3 | 1.2 | 1.8 | 1.0 | 0.1 |
| | positive | | | | | | | | | | | | |
| | electrode | | | | | | | | | | | | |
| | (gf/mm) | | | | | | | | | | | | |
| | Adhesion of | 0.9 | 1.0 | 1.1 | 1.0 | 0.9 | 0.6 | 0.4 | 0.3 | 0.9 | 1.2 | 1.2 | 0.2 |
| | negative | | | | | | | | | | | | |
| | electrode | | | | | | | | | | | | |
| | adhesion | | | | | | | | | | | | |
| | (gf/mm) | | | | | | | | | | | | |
| | Adhesion of | 1.2 | 1.4 | 1.6 | 1.5 | 1.2 | 0.9 | 0.8 | 0.6 | 2.1 | 3.0 | 2.2 | 0.3 |
| | positive | | | | | | | | | | | | |
| | electrode | | | | | | | | | | | | |
| | adhesion + | | | | | | | | | | | | |
| | Adhesion of | | | | | | | | | | | | |
| | negative | | | | | | | | | | | | |
| | electrode | | | | | | | | | | | | |
| | (gf/mm) | | | | | | | | | | | | |
| Wetting | Adhesion of | 1.3 | 1.5 | 1.6 | 1.5 | 1.3 | 0.8 | 0.0 | 1.0 | 1.0 | 0.8 | 1.6 | 0.3 |
| | positive | | | | | | | | | | | | |
| | electrode | | | | | | | | | | | | |
| | adhesion | | | | | | | | | | | | |
| | (gf/mm) | | | | | | | | | | | | |
| | Adhesion of | 0.4 | 0.5 | 0.5 | 0.6 | 0.4 | 0.5 | 0.1 | 0.5 | 0.5 | 0.7 | 0.9 | 0.1 |
| | negative | | | | | | | | | | | | |
| | electrode | | | | | | | | | | | | |
| | (gf/mm) | | | | | | | | | | | | |
| | Adhesion of | 1.7 | 2.0 | 2.1 | 2.1 | 1.7 | 1.3 | 0.1 | 1.5 | 1.5 | 1.5 | 2.5 | 0.4 |
| | positive | | | | | | | | | | | | |
| | electrode + | | | | | | | | | | | | |
| | Adhesion of | | | | | | | | | | | | |
| | negative | | | | | | | | | | | | |
| | electrode | | | | | | | | | | | | |
| | (gf/mm) | | | | | | | | | | | | |

| | | | | | | | | | | | | |
|---|---|---|---|---|---|---|---|---|---|---|---|---|
| Change in air permeability | 35 | 37 | 42 | 40 | 30 | 50 | 20 | 37 | 1000 | 200 | 1000 | 30 |
| (sec) | | | | | | | | | | | | |
| High-temperature cycle- | 87 | 87 | 86 | 85 | 87 | 86 | 78 | 84 | 72 | 80 | 72 | 82 |
| life (%) | | | | | | | | | | | | |

The separators of the Examples simultaneously secured adhesion, air permeability, and high-temperature cycle-life characteristics.

By way of summation and review, in order to help reduce or prevent short-circuit between the positive and negative electrodes in rechargeable lithium batteries, olefin substrates may be used as separators. The olefin substrate may have the advantage of excellent flexibility, and may have rapid heat shrinkage at high temperatures of 100° C. or higher.

In order to address the rapid heat shrinkage, a method of forming an inorganic particle coating layer on at least one surface of the olefin substrate has been proposed. Heat resistance and adhesion may be in a trade-off relationship. An inorganic particle coating layer may be on at least one surface of the olefin substrate, and although heat resistance may be ensured, adhesion may not be achieved.

One or more embodiments may provide a separator for a rechargeable lithium battery that simultaneously secures heat resistance and adhesion.

The separator according to some embodiments may help simultaneously secure heat resistance and adhesion, thereby improving cycle-life characteristics of a rechargeable lithium battery at ambient temperature or high temperature.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A separator for a rechargeable lithium battery, the separator comprising:
a substrate;
a heat resistant layer on the substrate; and
an adhesive layer on the heat resistant layer,
wherein:
the heat resistant layer includes:
inorganic particles, and
a salt-based heat resistant binder,
the adhesive layer includes:
a first adhesive binder including PVdF-acrylate;
a PVdF homopolymer second adhesive binder; and
a P(VdF-co-HFP) copolymer third adhesive binder,
the third adhesive binder has a weight ratio of VdF and HFP of about 95:5 to about 50:50 and includes a C═O functional group of a (meth)acrylic acid monomer, and
the adhesive layer includes:
about 10 to about 40 wt % of the first adhesive binder;
about 30 to about 80 wt % of the second adhesive binder; and
about 10 to about 40 wt % of the third adhesive binder, all wt % being based on a total weight of the adhesive layer.

2. The separator as claimed in claim 1, wherein the PVdF-acrylate in the first adhesive binder has an inter-penetrating network polymer (IPN) structure.

3. The separator as claimed in claim 1, wherein the second adhesive binder includes a C═O functional group of a (meth)acrylic acid monomer.

4. The separator as claimed in claim 1, wherein a melting point of the second adhesive binder is greater than or equal to about 130° C.

5. The separator as claimed in claim 1, wherein the salt-based heat resistant binder includes:
a first structural unit including a structural unit of a (meth)acrylic acid or (meth)acrylate and a structural unit of a (meth)acrylamide; and
a second structural unit of a (meth)acrylamidosulfonic acid or a salt thereof.

6. The separator as claimed in claim 5, wherein the salt-based heat resistant binder is a poly (acrylic acid-co-acrylamide-co-sodium 2-acrylamido-2-methylpropanesulfonate salt).

7. The separator as claimed in claim 1, wherein the heat resistant layer further includes a swellable binder of core-shell structure.

8. The separator as claimed in claim 1, wherein the inorganic particles include boehmite, silica (SiO₂), alumina (Al₂O₃), titania (TiO₂), clay, BaSO₄, MgO, Mg(OH)₂, or a combination thereof.

9. The separator as claimed in claim 1, wherein the inorganic particles have a D50 particle diameter of about 100 to about 700 nm.

10. The separator as claimed in claim 1, wherein the heat resistant layer includes:
about 70 to about 99 wt % of the inorganic particles, and
about 1 to about 30 wt % of the heat resistant binder, all wt % being based on a total weight of the heat resistant layer.

11. The separator as claimed in claim 1, wherein the heat resistant layer and the adhesive layer are respectively on both surfaces of the substrate.

12. A rechargeable lithium battery, comprising:
a positive electrode;
a negative electrode; and
the separator as claimed in claim 1 between the positive electrode and the negative electrode.
